(19) United States
(12) Patent Application Publication
(10) Pub. No.: US 2026/0347098 A1
(43) Pub. Date: Nov. 5, 2026

(54) PACKER SYSTEM WITH AUTOMATIC FREQUENCY ADJUSTMENT

(71) Applicant: Oshkosh Corporation, Oshkosh, WI (US)

(72) Inventors: JACOB WALLIN, Oshkosh, WI (US); Ross Tumer, Oshkosh, WI (US); Derek Wente, Austin, MN (US); Jerrod Kappers, Oshkosh, WI (US); Quincy Wittman, Oshkosh, WI (US); Jason Rice, Oshkosh, WI (US); Joe Nelson, Oshkosh, WI (US)

(73) Assignee: Oshkosh Corporation, Oshkosh, WI (US)

(21) Appl. No.: 19/664,833

(22) Filed: Apr. 30, 2026

Related U.S. Application Data
(60) Provisional application No. 63/799,255, filed on May 2, 2025.

(51) Int. Cl. B65F 3/14

(52) U.S. Cl. CPC B65F 3/143; B65F 2003/146

(57) ABSTRACT

A refuse vehicle is provided. The refuse vehicle may include a chassis, a vehicle body, a packing assembly, a pressure sensor, and a controller. The chassis supports multiple wheels. The vehicle body is supported by the chassis and defines a receptacle for storing refuse. The packing assembly is disposed within the receptacle and actuatable to compact the refuse stored in the receptacle. The pressure sensor is configured to output sensor data indicative of pressure exerted by the packing assembly when the packing assembly is actuated. The controller is configured to receive the sensor data from the pressure sensor. The controller is further configured to generate a control signal to actuate the packing assembly at a pack frequency based on the sensor data.

### CROSS-REFERENCE TO RELATED APPLICATIONS

The present application claims the benefit of and priority to U.S. Provisional Patent Application No. 63/799,255, filed on May 2, 2025, the entire contents of which are hereby incorporated by reference herein.

### BACKGROUND

The present disclosure generally relates to the field of refuse vehicles and systems for compacting refuse received by a refuse vehicle.

### SUMMARY

An exemplary embodiment of the present disclosure relates to a refuse vehicle. The refuse vehicle may include a chassis, a vehicle body, a packing assembly, a pressure sensor, and a controller. The chassis supports multiple wheels. The vehicle body is supported by the chassis and defines a receptacle for storing refuse. The packing assembly is disposed within the receptacle and actuatable to compact the refuse stored in the receptacle. The pressure sensor is configured to output sensor data indicative of pressure exerted by the packing assembly when the packing assembly is actuated. The controller is configured to receive the sensor data from the pressure sensor. The controller is further configured to generate a control signal to actuate the packing assembly at a pack frequency based on the sensor data.

Another exemplary embodiment of the present disclosure relates to a controller. The controller may be configured to receive, from a sensor associated with a packing assembly, sensor data indicative of pressure exerted by the packing assembly. The controller may further be configured to determine, based on the sensor data, a peak pressure exerted by the packing assembly during actuation of the packing assembly to compact refuse within a refuse receptacle. The controller may further be configured to determine a pack frequency based on the peak pressure. The controller may further be configured to generate a control signal to actuate the packing assembly at the pack frequency.

Another exemplary embodiment of the present disclosure relates to a method of operating a packing assembly of a refuse vehicle. The method may include receiving, from a sensor associated with a packing assembly of a refuse vehicle, sensor data indicative of pressure exerted by the packing assembly. The method may further include determining, based on the sensor data, a peak pressure exerted by the packing assembly during actuation of the packing assembly to compact refuse within a receptacle of the refuse vehicle. The method may further include determining a pack frequency based on the peak pressure. The method may further include generating a control signal to actuate the packing assembly at the pack frequency.

Another exemplary embodiment of the present disclosure relates to a refuse vehicle. The refuse vehicle includes a chassis, a vehicle body, a packing assembly, a pressure sensor, and a controller. The chassis supports a plurality of wheels. The vehicle body is supported by the chassis and defines a receptacle for storing refuse therein. The packing assembly is disposed within the receptacle and actuatable to compact refuse stored in the receptacle. The pressure sensor is coupled to one of the packing assembly or the vehicle body. The pressure sensor is configured to output sensor data indicative of a peak pressure exerted by the packing assembly when the packing assembly is actuated. The controller is configured to receive sensor data from the pressure sensor and to adjust a pack frequency of the packing assembly based on the sensor data.

In some embodiments, the controller is configured to periodically actuate the packing assembly at a first rate in response to the sensor data being below a first threshold, to periodically actuate the packing assembly at a second rate in response to the sensor data being above the first threshold and below a second threshold, and to periodically actuate the packing assembly at a third rate in response to the sensor data being above the second threshold. In some embodiments, the refuse vehicle further includes a lifting system actuatable to engage a refuse container and deposit refuse from the refuse container into the receptacle. In some such embodiments, the first rate is once for every three actuations of the lifting system, the second rate is once for every two actuations of the lifting system, and the third rate is once for every actuation of the lifting system. In some embodiments, the first threshold is approximately 625 pounds per square inch and the second threshold is approximately 700 pounds per square inch. In some embodiments, the first threshold is approximately 1,000 pounds per square inch and the second threshold is approximately 1,500 pounds per square inch. In some embodiments, the first threshold is approximately 1,200 pounds per square inch and the second threshold is approximately 1,800 pounds per square inch. In some embodiments, the controller is further configured to receive an input indicative of a type of refuse to be collected by the refuse vehicle, and wherein the first threshold and the second threshold are based on the type of refuse to be collected by the refuse vehicle.

In some embodiments, the controller is configured to determine an average peak pack pressure based on the sensor data and periodically actuate the packing assembly at a rate based on the average peak pack pressure. In some embodiments, the controller is configured to periodically actuate the packing assembly at a first rate in response to the average peak pack pressure being below a first threshold, to periodically actuate the packing assembly at a second rate in response to the average peak pack pressure being above the first threshold and below a second threshold, and to periodically actuate the packing assembly at a third rate in response to the average peak pack pressure being above the second threshold.

Another exemplary embodiment of the present disclosure relates to a control system. The control system is configured to receive sensor data from a pressure sensor associated with a packing assembly of a refuse vehicle, the pressure sensor configured to output sensor data indicative of a peak pressure exerted by the packing assembly when the packing assembly is actuated. The control system is further configured to periodically actuate the packing assembly at a first rate in response to the sensor data being below a first threshold, periodically actuate the packing assembly at a second rate in response to the sensor data being above the first threshold and below a second threshold, and periodically actuate the packing assembly at a third rate in response to the sensor data being above the second threshold.

Another exemplary embodiment of the present disclosure relates to a method of operating a packing assembly of a refuse vehicle. The method includes receiving sensor data from a pressure sensor associated with the packing assembly, the pressure sensor configured to output sensor data indicative of a peak pressure exerted by the packing assembly when the packing assembly is actuated. The method further includes periodically actuating the packing assembly at a first rate in response to the sensor data being below a first threshold, periodically actuating the packing assembly at a second rate in response to the sensor data being above the first threshold and below a second threshold, and periodically actuating the packing assembly at a third rate in response to the sensor data being above the second threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment;

FIG. 2 is a schematic diagram of a control system for the refuse vehicle of FIG. 1, according to an exemplary embodiment;

FIG. 3 is a flow diagram of a method for controlling the refuse vehicle of FIG. 1, according to an exemplary embodiment;

FIG. 4 is a front view of a user interface for the control system of FIG. 2 showing a first display screen of the user interface, according to an exemplary embodiment;

FIG. 5 is another front view of the user interface of FIG. 2 showing a second display screen indicating performance metrics associated with a lifting system of the refuse vehicle, according to an exemplary embodiment;

FIG. 6 is another front view of the user interface of FIG. 2 showing a third display screen indicating a collection mode selector options for the user interface, according to an exemplary embodiment; and

FIG. 7 is a flow diagram of a method for controlling the refuse vehicle of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Refuse vehicles (e.g., garbage trucks, waste collection trucks, sanitation vehicles, etc.) include vehicles configured to collect, process, and transport refuse. A refuse vehicle may include a lifting system (e.g., a lifter, a lift assembly, lift arms, etc.) to engage refuse containers and to deposit refuse from the refuse containers into a receptacle (e.g., a storage volume, a storage compartment, a refuse compartment, etc.) of the refuse vehicle. The refuse vehicle may additionally include a compactor (e.g., a packing assembly, a packing system, a packer, a pack and eject system) configured to compact refuse within the receptacle to better utilize the space within the receptacle. To eliminate the need for frequent operator interaction, and thus reduce opportunity for error, the refuse vehicle may be configured to automatically actuate the compactor at regular intervals. However, as the quantity of refuse deposited into the receptacle of the refuse vehicle increases, the packing performance may be altered or reduced. Additionally, different types of refuse (e.g., recyclables, mixed trash, organic waste, etc.) may respond differently to the same packing pressure exerted on the refuse by the compactor.

Referring generally to the figures, a compaction control system for a refuse vehicle is shown that is configured to automatically adjust actuation frequency of the compactor based on an average packing pressure exerted by the compactor on refuse material. The refuse vehicle may include a pressure sensor configured to measure and output data indicative of a pressure exerted by the compactor as it is actuated to compact refuse material within a receptacle of the refuse vehicle. The refuse vehicle may also include a controller configured to receive the sensor data and to determine an actuation rate (e.g., a pack frequency) to automatically actuate the compactor based on the sensor data. In some embodiments, the controller is configured to increase the actuation rate when the sensor data indicates greater pressure is required to compact the refuse within the receptacle, which can increase pack density as the amount of refuse material increases within the receptacle during a refuse collection route. In some embodiments, the controller is further configured to operate in different modes (e.g., operation modes, collection modes, etc.) related to (e.g., based on) the type of refuse being collected and to automatically adjust the manner in which the compactor operates based on a combination of the mode and the packing pressure. Such an arrangement can improve overall refuse vehicle capacity during operation in a way that accounts for various different types of refuse materials that may be collected.

### Refuse Vehicle

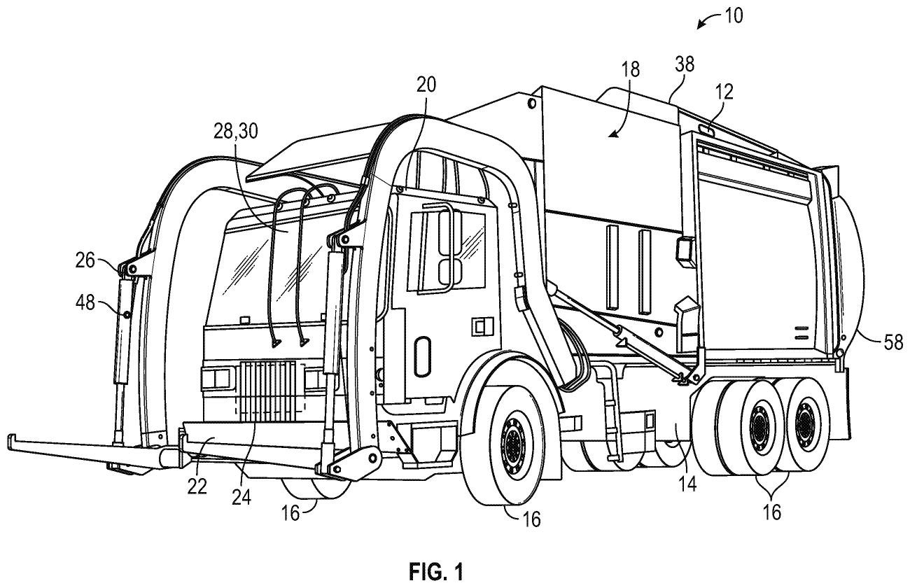

Referring to FIG. 1, a refuse vehicle 10 is adapted for retrieving and hauling refuse from waste containers, such as residential and/or commercial garbage cans, to a transfer station, such as a landfill or another waste disposal area. The refuse vehicle 10 is depicted as a front end loader but can also take the form of a rear end loader or side loader, for example, that is arranged to lift and transfer contents of a waste container into an on-board receptacle 12. The refuse vehicle 10 has a vehicle chassis 14 that generally supports wheels 16, a vehicle body 18, and the receptacle 12. The vehicle body 18 can include a cab 20 and a motor housing 22 that receives a motor 24. In some embodiments, the vehicle body defines the receptacle 12. The motor 24 can produce rotational power that can then be transmitted to the wheels 16 through a transmission to drive the refuse vehicle 10.

The on-board receptacle 12 can be sized to receive the contents of several waste containers (e.g., dumpsters, bins, refuse containers, etc.) so that the refuse vehicle 10 can execute an extended route that includes several stops. Upon arriving at each site, a lifting system 26 (e.g., a hydraulic arm assembly) can be actuated to engage and raise a waste container until an opening of the waste container is inverted or angled downward toward the on-board receptacle 12. Aided by gravity, waste falls out of the opening of the waste container and into the on-board receptacle 12. The waste container can then be lowered to the ground and disengaged from the lifting system 26 so that the refuse vehicle 10 can drive to another location along its route and repeat the waste removal process.

The refuse vehicle 10 also includes a control system 28, which can be at least partly positioned within the cab 20 of the refuse vehicle 10, for example, to aid a driver in performing different vehicle tasks (e.g., a user interface of the control system 28). The control system 28 can provide operating instructions to various vehicle subsystems 44, including a steering system, the lifting system 26, a compactor 46 (e.g., a waste compactor, a packing assembly, a packer, a pack and eject system, etc.) disposed within the on-board receptacle 12, a power take-off (PTO) shaft, the motor 24, cab climate controls, and/or other adjustable systems aboard the refuse vehicle 10. A controller 30 can issue instructions or commands to each system within the refuse vehicle 10 to execute desired vehicle functions.

### Control System

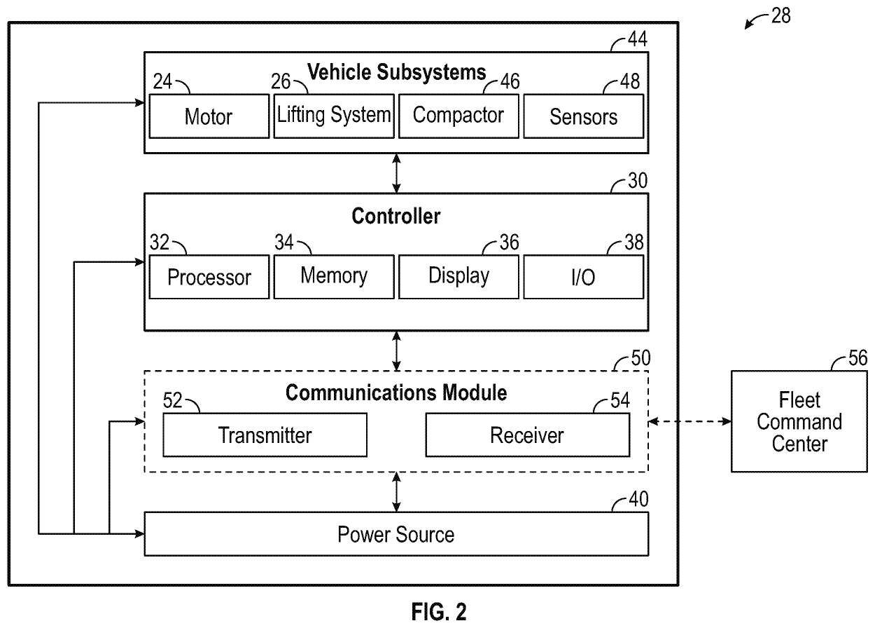

Referring to FIG. 2, the control system 28 can include an on-board power source 40 (e.g., a battery) to provide electrical power to each of the components within the control system 28. The control system 28 includes a controller 30 (e.g., control circuitry, processing circuitry, a vehicle control unit, etc.). The controller 30 includes one or more processors 32 operatively connected and configured to execute instructions stored on a memory 34. The one or more processors 32 can be implemented as general-purpose processors, one or more application specific integrated circuit (ASIC), one or more field programmable gate arrays (FPGAs), a group of processing components, or other suitable electronic processing components.

The memory 34 (e.g., memory, memory unit, storage device, etc.) can include one or more devices (e.g., RAM, ROM, flash memory, hard disk storage, etc.) for storing data and/or computer code for completing or facilitating the various processes, layers, and modules described in the present disclosure. The memory 34 can be or include volatile memory or non-volatile memory. The memory 34 can include database components, object code components, script components, or any other type of information structure for supporting the various activities and information structures described in the present application. According to some embodiments, memory 34 is communicably connected to the one or more processors 32 and includes computer code for executing one or more processes described herein.

The controller 30 may additionally include a display 36 and one or more user input and/or output devices 38. The display 36 is configured to present information to an operator of the refuse vehicle 10. In some embodiments, the display 36 is a touchscreen display configured to present information to and receive input from the operator of the refuse vehicle 10. The one or more user input and/or output devices 38 may include buttons, knobs, switches, LEDs, speakers, buzzers, a steering wheel, a throttle, joysticks, etc. to receive inputs from or provide information to the operator of the refuse vehicle 10.

The controller 30 issues commands and instructions to the vehicle subsystems 44 positioned about the vehicle. The vehicle subsystems 44 may include the motor 24, the lifting system 26, the compactor 46, sensors 48 positioned about the refuse vehicle 10, or other suitably controlled aspects of the refuse vehicle 10. Each of the vehicle subsystems 44 can be powered by the power source 40 and operated using one or more user input and/or output devices 38.

In some embodiments, the control system 28 includes a communications module 50 to send and receive data from an external source. For example, the communications module 50 may include a transmitter 52 that can communicate with an external computer (e.g., a fleet command center 56) or a network to send data related to vehicle operational modes or performance. The communications module 50 can further include a receiver 54 that can communicate with an external computer or network to receive instructions, data, updated operational modes and performance parameters, and other data that may advantageously be used to operate the refuse vehicle 10. Using the communications module 50, a refuse vehicle 10 can be remotely controlled or monitored to ensure optimized performance is occurring.

### Automatic Compactor Actuation

In some embodiments, the controller 30 is configured to generate and/or transmit control signals to periodically actuate the compactor 46. The controller 30 may be configured to actuate the compactor 46 at a rate related to (e.g., based on) the number of times the lifting system 26 is actuated so that refuse within the receptacle 12 of the refuse vehicle 10 is automatically compacted as it is deposited into the receptacle 12 by the lifting system 26. In such embodiments, the controller 30 may be configured to generate a control signal to the packer/compactor actuator to actuate the compactor responsive to actuation of the lifting system 26. For example, the controller 30 may be configured to actuate the compactor 46 once for every time the lifting system 26 is actuated. In another example, the controller 30 may be configured to actuate the compactor 46 twice for every time the lifting system 26 is actuated. In still another example, the controller 30 may be configured to actuate the compactor 46 once for every two times the lifting system 26 is actuated. In still another example, the controller 30 may be configured to actuate the compactor 46 once for every three times the lifting system 26 is actuated. In some embodiments, varying the compaction frequency relative to actuations of the lifting system 26 can improve overall capacity and utilization of the receptacle 12 by adjusting how often the compactor 46 is actuated as refuse accumulates within the receptacle 12.

In some embodiments, the controller 30 is configured to change the rate at which the compactor 46 is actuated based on a quantity of refuse material within the receptacle 12 (e.g., to increase the actuation rate as the quantity of refuse within the receptacle 12 increases). In some such embodiments, the sensors 48 of the control system 28 include a pressure sensor. The pressure sensor may be coupled to one of the receptacle 12, the vehicle body 18, or a component of the compactor 46 (e.g., an actuator, a hydraulic actuator, a hydraulic pump, etc.). In some embodiments, the pressure sensor may include a hydraulic pressure sensor, a pressure transducer, a strain-gauge-based pressure sensor, or another sensor configured to output data indicative of pressure exerted by the compactor 46. The pressure sensor is configured to output sensor data indicative of the pressure exerted by the compactor 46 when the compactor 46 is actuated to compact refuse within the receptacle 12. The pressure exerted by the compactor 46 as the compactor 46 is actuated to compact refuse within the receptacle 12 may increase as the quantity of refuse within the receptacle 12 increases. Accordingly, the sensor data output by the pressure sensor may relate to, or be indicative of, the quantity of refuse within the receptacle 12 and/or the types of refuse materials being compacted.

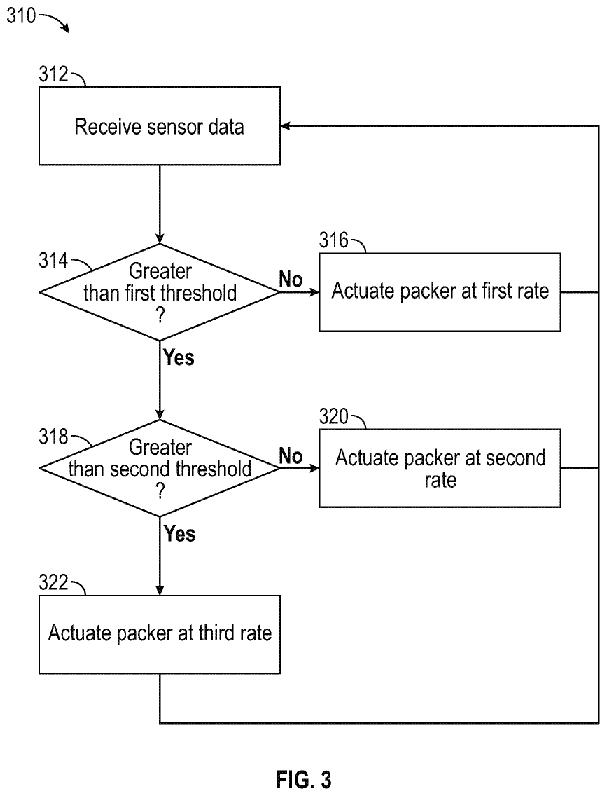

Referring to FIG. 3, a flow diagram for a method 310 for varying the rate/frequency at which the compactor 46 is actuated as the quantity of refuse within the receptacle 12 increases is shown, according to an exemplary embodiment. The method 310 may be implemented by the controller 30 and will therefore be described with reference to FIG. 2. In other embodiments, the method 310 may include additional, fewer, and/or different steps.

The method 310 includes receiving sensor data, at operation 312. In some embodiments, operation 312 includes receiving, by the controller 30 from the pressure sensor and/or an intermediate controller or signal processor, sensor data indicative of the pressure exerted by the compactor 46 as it is actuated to compact refuse within the receptacle 12 of the refuse vehicle 10. In some embodiments, operation 312 includes processing the sensor data (e.g., filtering, thresholding, averaging, etc.). For example, the controller 30 may process the sensor data to determine, identify, or isolate the peak pressure exerted by the compactor 46 as it is actuated. In some embodiments, the controller 30 determines a peak pressure exerted by the compactor 46 during an actuation of the compactor 46 and actuates the compactor 46 at a selected pack frequency based on the determined peak pressure.

In another example, the controller 30 may average the sensor data over successive actuations of the compactor 46 to determine an average pressure exerted by the compactor 46 as the compactor 46 is actuated. In some embodiments, the controller 30 performs a combination of these actions. For example, the controller 30 may first process the sensor data to identify the peak pressure exerted by the compactor 46 during actuation. The controller 30 may then average the peak pressure over successive actuations of the compactor 46 to determine an average peak pressure exerted by the compactor 46 during actuation. In an exemplary embodiment, the controller 30 may average the peak pressure exerted by the compactor 46 as it is actuated over a threshold number of actuations, such as 10, 20, or 30 successive actuations to determine the average peak pressure. Such a configuration can provide a more accurate measurement of pack pressure that avoids noise associated with individual pack events.

In some embodiments, if the number of compactor actuations that have occurred since the refuse vehicle 10 has been emptied of waste (e.g., the tailgate has been fully opened, or otherwise actuated) is less than the threshold, the controller 30 may average peak pressure over the number of actuations of the compactor 46 that have occurred since the refuse vehicle 10 was last emptied of waste (e.g., a number of actuations since the tailgate of the refuse vehicle 10 was actuated). When the refuse vehicle 10 is emptied of waste, the peak pressure, or average peak pressure may be reset to zero to enable resetting of the system to a default number of actuations per lifting cycle.

In some embodiments, the number of successive actuations averaged to identify the average peak pressure is programmable by the operator of the refuse vehicle 10 (e.g., the operator of the refuse vehicle 10 may provide the controller 30 with a desired number of successive actuations to average via the display 36 or the one or more user input and/or output devices 38).

The method 310 includes determining if the sensor data exceeds a first threshold pressure, at operation 314. In some embodiments, operation 314 includes comparing, by the controller 30, the sensor data received, processed, and/or averaged at operation 312 to the first threshold pressure to determine if the sensor data exceeds the first threshold pressure. In some embodiments, the first threshold pressure is programmable by the operator of the refuse vehicle 10 (e.g., the operator of the refuse vehicle 10 may provide the controller 30 with a desired first threshold pressure via the display 36 or the one or more user input and/or output devices 38).

When it is determined at operation 314 that the sensor data received, processed, and/or averaged at operation 312 does not exceed (e.g., is less than) the first threshold pressure, the method 310 includes the step of periodically actuating the compactor 46 at a first rate, at operation 316. In some embodiments, operation 316 includes periodically providing, by the controller 30 to the compactor 46, control signals to actuate the compactor 46 at the first rate. In some embodiments the first rate is related to (e.g., based on) the number of times the lifting system 26 is actuated to deposit refuse in the receptacle 12 of the refuse vehicle 10. In some embodiments, the first rate is once for every three times the lifting system 26 is actuated or another threshold number of lift operations. Such an arrangement can balance energy consumption with the need for increased pack density.

When it is determined at operation 314 that the sensor data received, processed, and/or averaged at operation 312 does exceed (e.g., is greater than or equal to, or otherwise satisfies) the first threshold pressure, the method 310 includes the step of determining if the sensor data exceeds a second threshold pressure, at operation 318. In some embodiments, the sensor data received, processed, and/or averaged at operation 312 is compared, by the controller 30, to the second threshold pressure to determine if the sensor data exceeds the second threshold pressure. In some embodiments, the second threshold pressure is programmable by the operator of the refuse vehicle 10 (e.g., the operator of the refuse vehicle 10 may provide the controller 30 with a desired second threshold pressure via the display 36 or the one or more user input and/or output devices 38). In some embodiments, the second threshold pressure is greater than the first threshold pressure. For example, the second threshold pressure may be at least about 10 percent greater than the first threshold pressure. By way of another example, the second threshold pressure may be between about 10 percent and about 50 percent greater than the first threshold pressure.

When it is determined at operation 318 that the sensor data received, processed, and/or averaged at operation 312 does not exceed (e.g., is less than) the second threshold pressure, the method 310 includes the step of periodically actuating the compactor 46 at a second rate, at operation 320. In some embodiments, operation 320 includes periodically providing, by the controller 30 to the compactor 46, control signals to actuate the compactor 46 at the second rate. In some embodiments the second rate is related to the number of times the lifting system 26 is actuated to deposit refuse in the receptacle 12 of the refuse vehicle 10. In some embodiments, the second rate is once for every two times the lifting system 26 is actuated or another second threshold number of lift operations.

When it is determined at operation 318 that the sensor data received, processed, and/or averaged at operation 312 does exceed (e.g., is greater than or equal to) the second threshold pressure, the method 310 includes the step of periodically actuating the compactor 46 at a third rate, at operation 322. In some embodiments, operation 322 includes periodically providing, by the controller 30 to the compactor 46, control signals to actuate the compactor 46 at the third rate. In some embodiments the third rate is related to the number of times the lifting system 26 is actuated to deposit refuse in the receptacle 12 of the refuse vehicle 10. In some embodiments, the third rate is once for every time the lifting system 26 is actuated or another third threshold number of lift operations. Coordinating the frequency of actuation with the number of lift cycles can, beneficially, reduce the risk of compaction during a lift event, and can also account for new materials introduced into the refuse stream more uniformly.

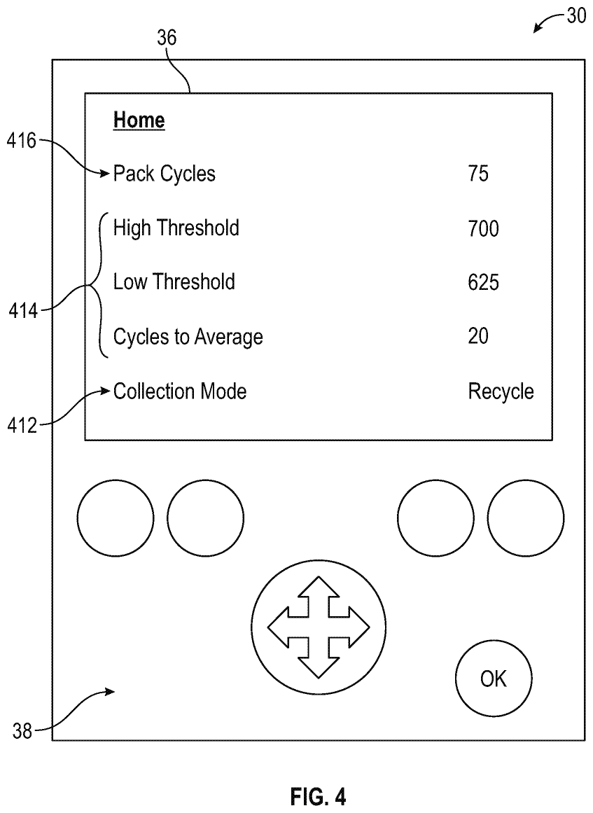

As described below in reference to FIGS. 4-6, different types of refuse may respond differently to compaction pressure, such that different threshold pressures and different compaction frequencies may be desired for different types of refuse. In some embodiments, method 310 further includes receiving (e.g., by the controller 30) an indication of an operation mode or collection mode corresponding to a type of refuse to be collected by the refuse vehicle 10 (e.g., from the display 36 or the fleet command center 56). The method 310 may then include selecting the first threshold pressure and the second threshold pressure based on the indicated operation mode or collection mode. For example, when the indicated operation mode or collection mode corresponds to recyclable waste, the first threshold pressure may be approximately 625 pounds per square inch and the second threshold pressure may be approximately 700 pounds per square inch. When the indicated operation mode or collection mode corresponds to mixed waste, the first threshold pressure may be approximately 1,000 pounds per square inch and the second threshold pressure may be approximately 1,500 pounds per square inch. When the indicated operation mode or collection mode corresponds to a third type of waste, the first threshold pressure may be approximately 1,200 pounds per square inch and the second threshold pressure may be approximately 1,800 pounds per square inch.

### Performance Parameters and Operation Modes

In reference to FIGS. 4-6, in some embodiments, the operator of the refuse vehicle 10 can interact with the controller 30 through the display 36. The display can present a graphical user interface that allows a user to monitor operational parameters of the refuse vehicle 10 as well as input commands to the various vehicle subsystems 44. As previously described, the display 36 may be a touch screen display and/or the display 36 may be accompanied by one or more user input devices (e.g., buttons, joysticks, etc.) that may be used to toggle through and select a desired input. The one or more user input devices may constitute one or more of the one or more user input and/or output devices 38.

Using the control system 28 and the controller 30, the operator of the refuse vehicle 10 can input various operating parameters to alter the performance of the refuse vehicle 10. For example, where the controller 30 is configured to periodically actuate the compactor 46, the operator of the refuse vehicle 10 may input a desired rate at which to periodically actuate the compactor 46. By way of another example, where the controller 30 is configured to change the rate at which the compactor 46 is actuated as the quantity of refuse within the receptacle 12 of the refuse vehicle 10 increases (e.g., according to method 310), the operator of the refuse vehicle 10 may input a desired first rate, second rate, third rate, first threshold pressure, and/or second threshold pressure.

Additionally or alternatively, the refuse vehicle 10 can be operated in different preset operation modes to more efficiently complete different tasks that may be assigned to the refuse vehicle 10. Each operation mode can include a series of stored system configurations or performance parameters that are optimized for the specific vehicle or the specific task to be performed. The preset operation modes and associated performance parameters can be stored within and accessed from the memory 34 that is in communication with the one or more

### Processors 32.

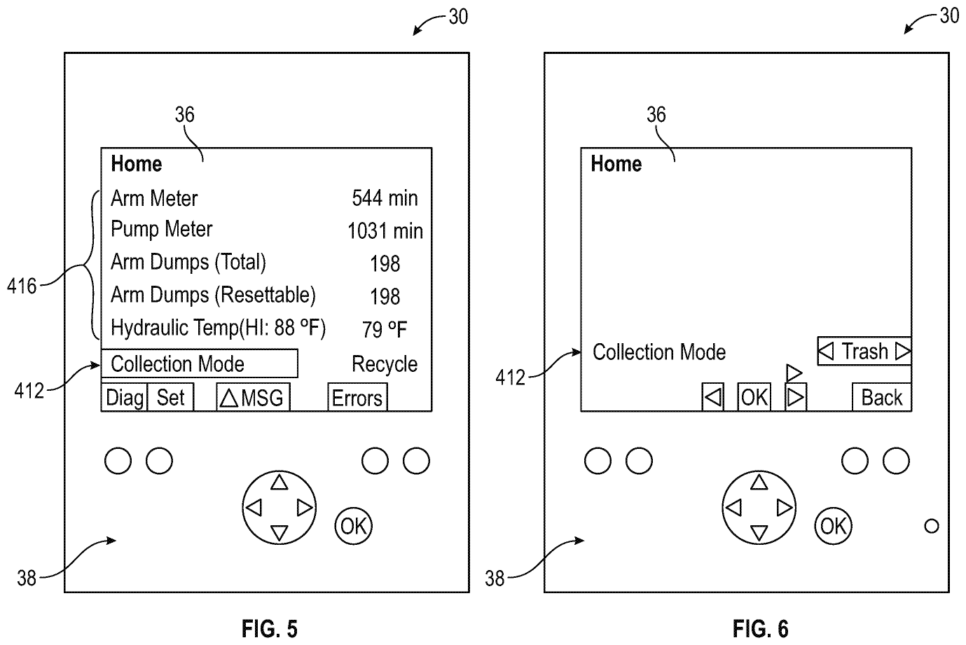

The same refuse vehicle 10 may be used to collect and transport different types of waste, and the preferred collection process may vary by waste type. As shown in FIGS. 5 and 6, the same refuse vehicle 10 may be used to handle either recycling or trash, and the preferred operational mode changes depending on the selection. Before beginning a route or driving the refuse vehicle 10, the operator of the refuse vehicle 10 may first be prompted by the display 36 to select the type of waste to be collected. Using inputs in communication with the display 36 or the display itself (e.g., a touch screen display), the operator of the refuse vehicle 10 can then select from a list 412, or some other representation of selectable options, a collection mode that corresponds to the proper waste material type. Alternatively, the type of waste to be collected can be determined automatically based upon the day of operation (e.g., if there are designated recycling or garbage collection days). In some embodiments, the type of waste to be collected can be input remotely from a fleet command center 56 or network computer in communication with the control system 28 of the refuse vehicle 10. In other embodiments, the type of material being collected can be determined based upon characteristics (e.g., size, shape, color, etc.) of the waste container being accessed, as determined by a sensor 48.

In some embodiments, the selected operational mode or collection mode may correspond not only to a general waste category, but also to a material type or material condition of the refuse, such as recyclable materials, mixed waste, dry trash, wet trash, or another refuse type.

Selecting “trash” or “recycling” (or another type of waste option, such as organic material) on the display 36 adjusts the operation mode of the refuse vehicle 10 to effectively deal with each different type of waste properly. If the recycling option is selected on the display 36, the one or more processors 32 can access the memory 34 storing specific performance parameters preset for performing a recycling route. Recyclable waste materials are generally lightweight and loosely packed (or entirely unpacked) materials and are advantageously compacted frequently to improve the overall capacity of the receptacle 12 of the refuse vehicle 10. Recyclable waste materials such as cardboard may exhibit spring-back after a compaction event. Accordingly, lower threshold pressures and more frequent compaction may be used to reduce spring-back effects and increase collection density within the receptacle 12. As such, parameters dictating the operation of the compactor 46 may be included within the performance parameters associated with the recycling operation mode.

In an exemplary embodiment, the recycling mode may have an associated performance parameter that causes the controller 30 to periodically actuate the compactor 46. The recycling mode may additionally have a performance parameter that causes the controller to vary the rate at which the compactor 46 is actuated as the quantity of refuse within the receptacle 12 of the refuse vehicle 10 increases (e.g., according to method 310). In such embodiments, the first rate, the second rate, the third rate, the first pressure threshold, and/or the second pressure threshold may be included in the performance parameters associated with the recycling mode. For example, when the recycling mode is selected, the first threshold pressure may be approximately 625 pounds per square inch, and the second threshold pressure may be approximately 700 pounds per square inch.

Selecting the trash option on the display 36 optimizes the refuse vehicle 10 to collect and transport trash (e.g., non-recyclable mixed waste). Performance parameters can be adjusted upon selecting the trash operation mode. The physical properties of trash may require less frequent compaction to optimize overall capacity of the receptacle 12 of the refuse vehicle 10. Additionally, trash may require greater force, or pressure, to effectively compact. Different mixed waste conditions may also respond differently to compaction. For example, wetter trash may tend to remain in a compacted state more readily than drier trash. Accordingly, higher threshold pressures and less frequent compaction may be used for refuse that remains compacted more readily, which can provide a desired amount of compaction with fewer compaction events and reduced energy consumption.

Accordingly, parameters dictating the operation of the compactor 46 may be included within the performance parameters associated with the trash operation mode. In an exemplary embodiment, the trash mode may have an associated performance parameter that causes the controller 30 to periodically actuate the compactor 46. The trash mode may additionally have a performance parameter that causes the controller to vary the rate at which the compactor 46 is actuated as the quantity of refuse within the receptacle 12 of the refuse vehicle 10 increases (e.g., according to method 310). In such embodiments, the first rate, the second rate, the third rate, the first pressure threshold, and/or the second pressure threshold may be included in the performance parameters associated with the trash mode. For example, when the trash mode is selected, the first threshold pressure may be approximately 1,000 pounds per square inch, and the second threshold pressure may be approximately 1,500 pounds per square inch.

Selecting a third type of waste option (e.g., organic material, a type of waste other than recyclable waste or mixed waste, etc.) on the display 36 optimizes the refuse vehicle 10 to collect and transport the third type of waste. In an exemplary embodiment, the third type of waste mode may have an associated performance parameter that causes the controller 30 to periodically actuate the compactor 46. The third type of waste mode may additionally have a performance parameter that causes the controller to vary the rate at which the compactor 46 is actuated as the quantity of refuse within the receptacle 12 of the refuse vehicle 10 increases (e.g., according to method 310). In such embodiments, the first rate, the second rate, the third rate, the first pressure threshold, and/or the second pressure threshold may be included in the performance parameters associated with the third type of waste mode. For example, when the third type of waste mode is selected, the first threshold pressure may be approximately 1,200 pounds per square inch, and the second threshold pressure may be approximately 1,800 pounds per square inch.

Each adjusted performance parameter can automate processes that may otherwise need to be performed manually by the operator of the refuse vehicle 10, which can help avoid mistakes during operation due to improper operation or failure to perform certain tasks.

In some embodiments, the controller 30 is configured to display performance parameters 414 associated with the selected operation mode. For example, and as shown in FIG. 4, the recycling operation mode has been selected, and the display 36 displays the first threshold pressure (shown as Low Threshold), the second threshold pressure (shown as High Threshold). The performance parameters displayed by the controller 30 may also include parameters dictating how sensor data is processed, filtered, or averaged. For example, and as shown in FIG. 4, the number of successive actuations of the packer over which the controller 30 averages the sensor data is displayed. In some embodiments, one or more of the displayed performance parameters may be adjusted by the operator of the refuse vehicle 10 after an operation mode has been selected to create a custom operation mode.

In some embodiments, the controller 30 is additionally or alternatively configured to display operating, or performance, metrics 416 of the refuse vehicle 10 as the refuse vehicle 10 completes a refuse collection route. For example, and as shown in FIG. 4, the controller 30 displays the number of times the compactor 46 has been actuated during a refuse collection route (shown as Pack Cycles). In another example, and as shown in FIG. 5, the controller 30 displays the amount of time the lifting system 26 has been used (shown as Arm Motor), the amount of time a hydraulic pump motor has been used (shown as Pump Motor), the number of times the lifting system 26 has been actuated (shown as Arm Dumps), and a present temperature associated with a hydraulic system (shown as Hydraulic Temp).

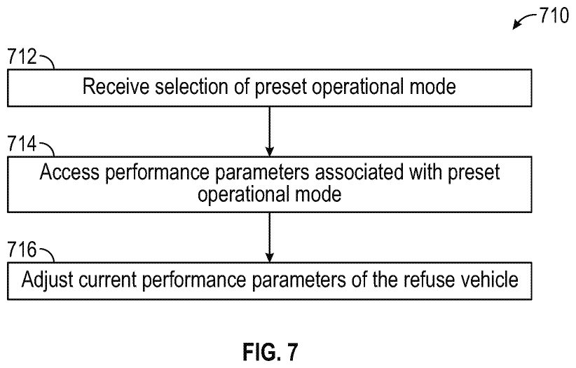

Referring to FIG. 7, a flow diagram for a method 710 for changing the operation mode of the refuse vehicle 10 is provided, according to an exemplary embodiment. The method 710 may be implemented by the controller 30 and will therefore be described with reference to FIG. 2. In other embodiments, the method 310 may include additional, fewer, and/or different steps.

The method 710 includes the step of receiving, by the controller 30, a selection of a preset operational mode, at operation 712. The selection of a preset operational mode can be made by an operator within the refuse vehicle 10, automatically based upon detected vehicle parameters (e.g., temperature, fuel source, engine size), or remotely. For example, a fleet command center can provide instructions, including a preset operational mode, to each refuse vehicle 10 within its command.

Alternatively, the selection of a preset operational mode, at operation 712 can be generated by the controller 30. The controller 30 can be in communication with an onboard GPS. The GPS, which can be included within the sensors 48 of the control system 28, monitors the location of the refuse vehicle 10 as the refuse vehicle 10 travels. The memory 34 can store a variety of different geographical indicators, such as “checkpoints” or geo-fences, which can be periodically compared with the current location of the refuse vehicle 10. If the refuse vehicle 10 crosses a stored geo-fence or reaches a checkpoint, for example, the controller 30 can transition the refuse vehicle 10 into a different operational mode. When the truck initially leaves to travel along a route, the controller 30 can compare the location of the refuse vehicle 10 to route maps or data stored within the memory 34. If the controller 30 determines that the location of the refuse vehicle 10 (or the recent path traveled by the refuse vehicle 10) matches a stored map location or route within the memory 34, the controller 30 can generate a selection to transition the refuse vehicle 10 to a different operational mode.

The method 710 includes the step of accessing, by the controller 30, performance parameters associated with the selected preset operational mode, at operation 714. As discussed previously, each preset operational mode optimizes the refuse vehicle 10 in a different way, based upon the tasks to be accomplished, the surrounding environmental conditions, or motor operation. The optimized performance parameters for each operational mode can be stored within a memory (e.g., memory 34) that can be accessed by the controller 30. The memory can be local or remote (e.g., cloud-based or network-based). The performance parameters may include packer frequency and pressure/force, hydraulic pump operation, heater operation, receptacle top door operation, vehicle subsystem operational levels and operational logic, sensor operation, and/or performance of other controllable or variable components on a refuse vehicle.

The method 710 includes the step of adjusting current performance parameters of the refuse vehicle to match the performance parameters accessed at operation 714, at operation 716. At operation 716, the controller 30 adjusts current performance parameters of the refuse vehicle to match the performance parameters accessed at operation 714. Adjusting the performance parameters of the vehicle to correspond with the values stored within the memory places the refuse vehicle in the selected preset operational mode chosen at operation 712. The display 36 can display additional options related to the selected operational mode or data sensed or otherwise received during operation of the refuse vehicle within the selected operational mode, for example. The refuse vehicle is then optimized to perform a specific task or perform within a specific set of operational constraints.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

References herein to a “remote computing system,” a “cloud,” or a “cloud computing system,” may include a computing system, or network of computing systems, having an edge computing device.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from the scope of the present disclosure or from the spirit of the appended claims.

What is claimed is:

1. A refuse vehicle, comprising:
a chassis supporting a plurality of wheels;
a vehicle body supported by the chassis and defining a receptacle for storing refuse;
a packing assembly disposed within the receptacle and actuatable to compact the refuse stored in the receptacle;
a pressure sensor configured to output sensor data indicative of pressure exerted by the packing assembly when the packing assembly is actuated; and
a controller configured to:
receive the sensor data from the pressure sensor; and
generate a control signal to actuate the packing assembly at a pack frequency based on the sensor data.

2. The refuse vehicle of claim 1, wherein the controller is further configured to determine, based on the sensor data, an average peak pack pressure over successive actuations of the packing assembly, wherein the pack frequency is based on the average peak pack pressure.

3. The refuse vehicle of claim 2, wherein the pack frequency is:
a first pack frequency when the average peak pack pressure is less than a first threshold;
a second pack frequency when the average peak pack pressure is greater than or equal to the first threshold and less than a second threshold; and
a third pack frequency when the average peak pack pressure is greater than or equal to the second threshold.

4. The refuse vehicle of claim 3, wherein the second pack frequency is greater than the first pack frequency, and the third pack frequency is greater than the second pack frequency.

5. The refuse vehicle of claim 4, further comprising a lifting system coupled to at least one of the chassis or the vehicle body and configured to engage a refuse container and deposit refuse from the refuse container into the receptacle, wherein the pack frequency varies based on a number of actuations of the lifting system.

6. The refuse vehicle of claim 5, wherein:
the first pack frequency is once for every three actuations of the lifting system;
the second pack frequency is once for every two actuations of the lifting system; and
the third pack frequency is once for every actuation of the lifting system.

7. The refuse vehicle of claim 3, wherein the controller is further configured to receive an input indicative of a type of refuse to be collected by the refuse vehicle, and wherein the first threshold and the second threshold are based on the type of refuse to be collected by the refuse vehicle.

8. The refuse vehicle of claim 7, wherein, when the type of refuse comprises mixed waste, the first threshold and the second threshold are greater than when the type of refuse comprises recyclable waste.

9. The refuse vehicle of claim 8, wherein, when the type of refuse comprises a third type of waste other than recyclable waste and mixed waste, the first threshold and the second threshold are greater than when the type of refuse comprises mixed waste.

10. A controller configured to:
receive, from a sensor associated with a packing assembly, sensor data indicative of pressure exerted by the packing assembly;
determine, based on the sensor data, a peak pressure exerted by the packing assembly during actuation of the packing assembly to compact refuse within a refuse receptacle;
determine a pack frequency based on the peak pressure; and
generate a control signal to actuate the packing assembly at the pack frequency.

11. The controller of claim 10, wherein the pack frequency is:
a first pack frequency when the peak pressure is less than a first threshold;
a second pack frequency when the peak pressure is greater than or equal to the first threshold and less than a second threshold; and
a third pack frequency when the peak pressure is greater than or equal to the second threshold.

12. The controller of claim 11, wherein the second pack frequency is greater than the first pack frequency, and the third pack frequency is greater than the second pack frequency.

13. The controller of claim 12, wherein the pack frequency varies based on a number of actuations of a lifting system configured to engage a refuse container and deposit refuse from the refuse container into the refuse receptacle.

14. The controller of claim 13, wherein:
the first pack frequency is once for every three actuations of the lifting system;
the second pack frequency is once for every two actuations of the lifting system; and
the third pack frequency is once for every actuation of the lifting system.

15. The controller of claim 11, further configured to receive an input indicative of a type of refuse to be collected in the refuse receptacle, wherein the first threshold and the second threshold are based on the type of refuse to be collected.

16. A method of operating a packing assembly of a refuse vehicle, comprising:
receiving, from a sensor associated with a packing assembly of a refuse vehicle, sensor data indicative of pressure exerted by the packing assembly;
determining, based on the sensor data, a peak pressure exerted by the packing assembly during actuation of the packing assembly to compact refuse within a receptacle of the refuse vehicle;
determining a pack frequency based on the peak pressure; and
generating a control signal to actuate the packing assembly at the pack frequency.

17. The method of claim 16, wherein the pack frequency is:
a first pack frequency when the peak pressure is less than a first threshold;
a second pack frequency when the peak pressure is greater than or equal to the first threshold and less than a second threshold; and
a third pack frequency when the peak pressure is greater than or equal to the second threshold.

18. The method of claim 17, wherein the second pack frequency is greater than the first pack frequency, and the third pack frequency is greater than the second pack frequency.

19. The method of claim 17, wherein the pack frequency varies based on a number of actuations of a lifting system configured to engage a refuse container and deposit refuse from the refuse container into the receptacle.

20. The method of claim 17, further comprising receiving an input indicative of a type of refuse to be collected by the refuse vehicle, wherein the first threshold and the second threshold are based on the type of refuse to be collected.
